(19) United States
(12) Patent Application Publication
(10) Pub. No.: US 2011/0084059 A1
(43) Pub. Date: Apr. 14, 2011

(54) AUXILIARY SYSTEM FOR PLASTIC MOLDING

(75) Inventors: KIN-FU LU, TAIPEI HSIEN (TW); CHAO-CHANG TANG, TAIPEI HSIEN (TW)

(73) Assignee: DRAGONJET CORPORATION, TAIPEI HSIEN (TW)

(21) Appl. No.: 12/692,033

(22) Filed: Jan. 22, 2010

(30) Foreign Application Priority Data
Oct. 8, 2009 (TW) 098134079

(51) Int. Cl. H05B 3/02

(52) U.S. Cl. 219/479; 219/507

(57) ABSTRACT

An auxiliary system for plastic molding electrically connected to an electrical energy converter to provide a working energy for heating at least a mold includes a plurality of plastic processing equipment, a plurality of electrical heaters, and an electrical energy switch equipment. When the plastic processing equipment sends a working request signal to the electrical energy switch equipment, the electrical energy switch equipment sends a working energy to the electrical energy heater corresponding to the plastic processing equipment sending the working request signal for heating the mold.

This application claims the benefit of Taiwan Patent Application Serial No. 098134079, filed 8 Oct. 2009, the subject matter of which is incorporated herein by reference.

### FIELD OF THE INVENTION

The present invention relates to an auxiliary system for molding, and particularly relates to an auxiliary system for plastic molding.

### BACKGROUND OF THE INVENTION

It is well known that conventional plastic processing methods include the injection molding process, the blow molding process and the thermo forming process.

These plastic processing methods all include a particular step to rapidly heat the molds. For example, in U.S. Pat. No. 6,960,746, a movable inductive heating coil is introduced close to both sides of mold cavities so as to preheat and heat continuously the molds by the high frequency magnetic field, and thereby the plastic materials introduced to the mold cavities thereafter can be instantly raised to a high-temperature state.

In addition, in U.S. Pat. No. 5,762,972, an embedded a coil in a mold as a part of the mold is disclosed for applying electromagnetic energy through a high frequency wave or microwave to heat the mold as well as the plastic materials throughout a filling step.

Further, in the art, an E-Mold technology is to embed an electric heating rod into a mold for generating high temperatures to heat up the mold and the plastic materials inside the mold.

Conventionally, each plastic processing equipment needs at least one electrical heater. Referring to FIG. 1, it shows a schematic view of a conventional system for plastic molding. The conventional system includes an auxiliary system further including plural sets of electrical heating equipment (including three sets shown in the figure, 21a, 21b and 21c) and plural sets of plastic processing equipment (including three sets shown in the figure, 31a, 31b and 31c). As shown, the electrical heating equipment 21a, 21b and 21c are electrically connected to electrical energy converters 100a, 100b and 100c, respectively, for obtaining required work energy I1, I2 and I3.

The electrical heating equipment 21a, 21b and 21c further include individually electrical heaters 211a, 211b and 211c, power switch modules 212a, 212b and 212c, and control modules 213a, 213b and 213c. As shown, the electrical heaters 211a, 211b and 211c are electrically connected to the power switch modules 212a, 212b and 212c respectively, and the control modules 213a, 213b and 213c are electrically connected to the power switch modules 212a, 212b and 212c respectively.

The plastic processing equipment 31a, 31b and 31c include individually molds 311a, 311b and 311c and working signal communication modules 312 a, 312b and 312c. Moreover, the plastic processing equipment 31a, 31b and 31c respectively communicate with the control modules 213a, 213b and 213c. When the working signal communication modules 312a, 312b and 312c determine to start any electrical heater 211a, 211b or 211c to heat the corresponding mold 311a, 311b or 311c, corresponding working request signal S1, S2 or S3 is sent to the corresponding control module 213a, 213b or 213c. Thus, the control module 213a, 213b or 213c can control the corresponding power switch module 212a, 212b or 212c according to the working request signal S1, S2 or S3 so as to deliver work energy I4, I5 or I6 to the corresponding electrical heater 211a, 211b or 211c.

However, apart from the electrical heaters 211a, 211b and 211c, each set of the electrical heating equipment 21a, 21b and 21c needs to be installed with the power switch modules 212a, 212b and 212c and the control modules 213a, 213b and 213c. As a result, a substantial occupation space would be inevitable to accommodate the aforesaid facilities. Furthermore, when the plastic processing equipment 31a, 31b and 31c needs to expend electrical heating equipment 21a, 21b and 21c, the power switch modules 212a, 212b and 212c and the control modules 213a, 213b and 213c may need to be re-invested. Further, at least one electrical energy converter 100a, 100b or 100c needs to be installed for each addition of the electrical heating equipment 21a, 21b and 21c, which also increases the cost.

For example, as shown in FIG. 1, the system 200 for plastic molding includes three sets of plastic processing equipment 31a, 31b and 31c, three sets of electrical heating equipment 21a, 21b and 21c and at least three electrical energy converters 100a, 100b and 100c. Namely, nine sets of different equipment need to be included for the entire system 200. Such an arrangement needs money as well as the occupation space.

### SUMMARY OF THE INVENTION

Accordingly, it is an object of the present invention to provide an auxiliary system for plastic molding, which applies only one single set of the electrical energy switch equipment to control the electric-thermal energy conversion upon a plurality of electrical heaters so as to decrease the number of large equipment required in the entire system for plastic molding and thus further to save the cost and the space for the system for plastic molding.

In the present invention, the electrical energy switch equipment allots the electricity to the electrical heaters in respective needed times, and thereby a decrease in energy saving can be expected.

The auxiliary system for plastic molding includes a plurality of electrical heaters and a set of electrical energy switch equipment. The electrical heaters are disposed in correspondence to the molds of the plastic processing equipment. The electrical energy switch equipment electrically connected to the electrical energy converter includes a control module and an electrical energy distributing module. The control module is communicated with the plastic processing equipment to receive working request signals sent from the plastic processing equipment and further to send corresponding electrical energy distributing signals according to the working request signals. The electrical energy distributing module is electrically connected to the electrical heaters to receive the electrical energy distributing signals sent from the control module and further, according to the electrical energy distributing signals, to send an working energy to at least one of the electrical heaters corresponding with the working request signal sent from the plastic processing equipment.

In a preferable embodiment of the present invention, the plastic processing equipment includes a working signal communication module for sending the working request signal to the control module, periodically or at a predetermined state of meeting a particular working condition.

By introducing the auxiliary system for plastic molding in accordance with the present invention, only a single set of the electrical energy switch equipment is required, and thus cost in equipment investment can be greatly reduced, space for the installation can be reduced to a minimum, and the energy for running the equipment can be substantially saved.

### BRIEF DESCRIPTION OF THE DRAWINGS

The accompanying drawings are included to provide a further understanding of the present invention, and are incorporated in and constitute a part of this specification. The drawings illustrate embodiments of the invention together with the description, serve to explain the principals of the present invention.

FIG. 1 is a schematic block view of a conventional system for plastic molding.

FIG. 2 is a block diagram showing an auxiliary system for plastic molding in accordance with the present invention.

### DETAILED DESCRIPTION OF THE PREFERRED EMBODIMENTS

The present invention relates to an auxiliary system for molding, and particularly relates to an auxiliary system for plastic molding. The following embodiments are included to provide a further understanding to the present invention. Persons having ordinary skill in the art should know the embodiments are for better explanation of the present invention and are not for limiting the present invention. Preferable embodiments of the present invention are as below.

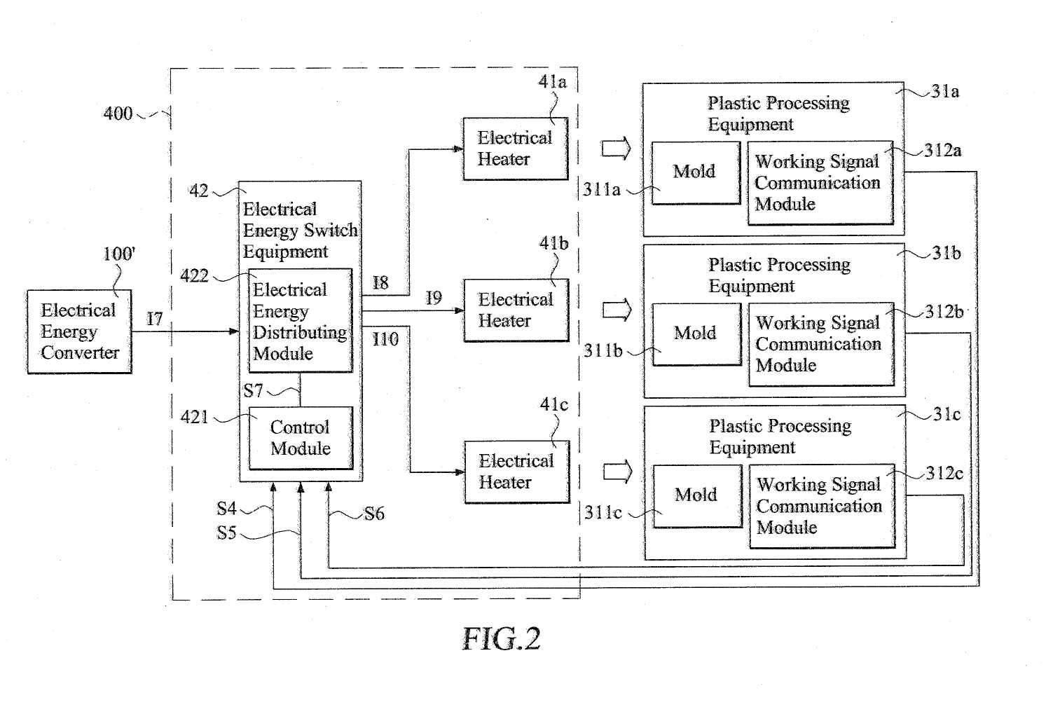

Referring to FIG. 2, a block diagram is used to show a preferred auxiliary system for plastic molding of the present invention. According to the present invention, the auxiliary system for plastic molding 400 is electrically connected to an electrical energy converter 100′ so as to obtain a total working energy I7 needed for the operation of the auxiliary system for plastic molding 400, is disposed near at least a set of plastic processing equipment (three 31a, 31b and 31c shown in the figure), and provides working energy I8, I9 and I10 to heat at least a mold (three 311a, 311b and 311c shown in the figure) of the plastic processing equipment 31a, 31b and 31c after the plastic processing equipment 31a, 31b and 31c sends a working request signal S4, S5 or S6. In the present invention, the electrical energy converter 100′ can be any apparatus that is able to provide electricity from any power supplying terminal such as a power generator.

The auxiliary system for plastic molding 400 includes a plurality of electrical heaters (three 41a, 41b and 41c shown in the figure), and a set of electrical energy switch equipment 42.

As shown, the three plastic processing equipments 31a, 31b and 31c respectively include three molds 311a, 311b and 311c (one for each foregoing equipment). The plastic processing equipments 31a, 31b and 31c respectively generate corresponding working request signal S4, S5 and S6. The plastic processing equipments 31a, 31b and 31c respectively include respective working signal communication modules 312a, 312b and 312c to send the working request signals S4, S5 and S6 to the electrical energy switch equipment 42. Furthermore, the communication means for sending the working request signals S4, S5 and S6 from the working signal communication modules 312a, 312b and 312c can be selected from the group of cable line communication, infrared transmission, Bluetooth transmission and radio frequency signal transmission.

The electrical heaters 41a, 41b and 41c are disposed with respect to the molds 311a, 311b and 311c of the corresponding plastic processing equipment 31a, 31b and 31c. The electrical heater 41a, 41b or 41c can be any heater which is able to convert electrical energy into thermal energy needed by the molds 311a, 311b and 311c. Preferably, the electrical heaters 41a, 41b and 41c are selected from the group of a resistance heater, an electromagnetic induction heater, a high frequency induction heater, a medium frequency induction heater, a low frequency induction heater, a microwave heater and an infrared sensing heater.

The electrical energy switch equipment 42 includes a control module 421 and an electrical energy distributing module 422. The control module 421 is communicated with the plastic processing equipment 31a, 31b and 31c so as to receive the working request signal S4, S5 and S6 sent from the plastic processing equipment 31a, 31b and 31c and to send an electrical energy distributing signal S7 accordingly.

The electrical energy distributing module 422 is electrically connected to the control module 421 and the electrical heaters 41a, 41b and 41c so as to receive the electrical energy distributing signal S7 sent from the control module 421, and sends working energy I8, I9 and I10 to at least one of the electrical heaters 41a, 41b and 41c corresponding with the plastic processing equipment 31a, 31b and 31c who originate the working request signal S4, S5 and S6 according to the electrical energy distributing signal S7.

Based on the above, compared with the conventional auxiliary system for plastic molding 200, the auxiliary system for plastic molding 400 of the present invention applies one set of the electrical energy switch equipment 42 to control the working energy I8, I9 and I10 of the electrical heaters 41a, 41b and 41c. As a result, a plurality of electrical heating equipment 21a, 21b and 21c and a plurality of electrical energy converters 100a, 100b and 100c are spared so as able to decrease the number of large equipment invested in the auxiliary system for plastic molding 400, and also to save the cost and the space for the system.

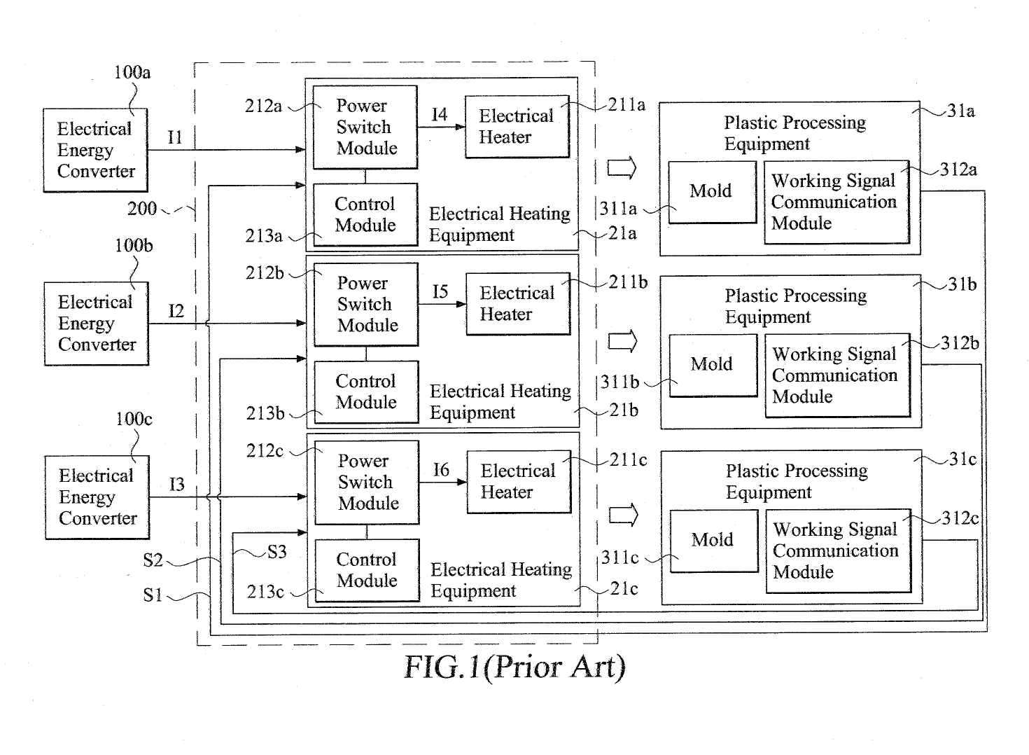

For example, if the user applies the auxiliary system for plastic molding 400 including three sets of plastic processing equipment 31a, 31b and 31c, the user only needs one more set of electrical energy switch equipment 42, one more electrical energy converter 100′ and three electrical heaters 41a, 41b and 41c. Only five sets of large equipment and three small devices need to be prepared for the entire auxiliary system for plastic molding 400, while, in the conventional design shown in FIG. 1, nine sets of large equipment need to be prepared for the auxiliary system for plastic molding 200. Obviously, the present invention indeed can decrease the cost and installment space needed for the system.

Moreover, the control module 421 records the received working request signal S4, S5 and S6 and sends the electrical energy distributing signal S7 according to a precedence of receipt so that the electrical energy distributing module 422 can send the working energy I8, I9 and I10 to the electrical heaters 41a, 41b and 41c corresponding to the working request signals S4, S5 and S6.

Besides, the control module 421 controls the electrical energy distributing module 422 to simply provide the working energy to one of the electrical heaters at one time. Therefore, the maximum value of the total working electrical energy I7 is equal to one of the working energy I8, I9 and I10 plus the basic electrical energy needed for the electrical energy switch equipment 42 itself.

Base on the above, when the control module 421 controls the electrical energy switch module 422 to provide the working energy I8, I9 or I10 needed by one of the electrical heaters 41a, 41b or 41c at one time, the maximum electrical energy load needed by the power supplying terminal is decreased so that the usage of electrical energy is more efficient.

Furthermore, according to a preferable embodiment of the present invention, the electrical heaters 41a, 41b and 41c can be assigned by respective predetermined priority. When the total working electrical energy I7 is larger than a predetermined maximum electrical energy load, the electrical energy distributing module 422 can stop providing at least one of the working energy I8, I9 and I10 to the electrical heaters 41a, 41b and 41c so as to lower the total working electrical energy I7 according to the sequence of the priority.

By providing the electrical energy switch equipment 42 to switch the working energy I8, I9 and I10 of the electrical heaters 41a, 41b and 41c in the present invention, the total working electrical energy I7 can be ensured not to be overflowed and thus away from possible power jump or damage in the power supplying terminal. Accordingly, the stability of the entire system for plastic molding can be assured.

Furthermore, the working signal communication modules 312a, 312b and 312c can send the working request signal S4, S5 and S6 to the control module 421 according to a working condition of the plastic processing equipment 31a, 31b and 31c, wherein the working condition of the plastic processing equipment 31a, 31b and 31c can be selected from the group of an injection speed, a holding time, a holding pressure, a filling speed, a cavity pressure, time to close the mold and time to end the injection. The parameter sent from the working request signals S4, S5 and S6 can be selected from the group of a starting time of heating, a total time of heating and a stopping time of heating.

Alternatively, the working signal communication modules 312a, 312b and 312c can send the working request signals S4, S5 and S6 to the control module 421 according to a predetermined working schedule time, wherein the predetermined working schedule time divides the electrical heaters 41a, 41b and 41c into a plurality of working groups and enforces only one of the electrical heaters 41a, 41b and 41c of one working group can be full-loaded at each unit of time.

Thus, the working signal communication modules 312a, 312b and 312c can send the working request signals S4, S5 and S6 according to the predetermined working schedule time, and thus only one of the electrical heaters 41a, 41b and 41c of one working group is in a status of starting the heating at each unit of time. Upon such an arrangement, the maximum electrical energy load needed by the power supplying terminal can be decreased and also the usage of electrical energy can be more economic and efficient.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An auxiliary system for plastic molding, electrically connected to an electrical energy converter, disposed near at least a set of plastic processing equipment, providing a working energy for heating at least a mold of the plastic processing equipment when the plastic processing equipment sends a working request signal, the auxiliary system for plastic molding comprising:
a plurality of electrical heaters disposed in correspondence to said at least a mold, and
an electrical energy switch equipment, electrically connected to the electrical energy converter, further comprising:
a control module, communicated with the plastic processing equipment to receive the working request signal sent from the plastic processing equipment and further to send an electrical energy distributing signal accordingly, and
an electrical energy distributing module, electrically connected to the plurality of electrical heaters to receive the electrical energy distributing signal sent from the control module and, according to the electrical energy distributing signal, to send a working energy to at least one of the plurality of electrical heaters corresponding with the plastic processing equipment sending the working request signal.

2. The auxiliary system for plastic molding according to claim 1, wherein the plastic processing equipment comprises a working signal communication module for sending the working request signal to the control module.

3. The auxiliary system for plastic molding according to claim 2, further including a predetermined working schedule time, wherein the working signal communication module sends the working request signal to the control module according to the predetermined working schedule time.

4. The auxiliary system for plastic molding according to claim 2, further including at least a working condition of the plastic processing equipment, wherein the working signal communication module sends the working request signal to the control module according to said at least a working condition.

5. The auxiliary system for plastic molding according to claim 4, wherein the working condition is selected from the group of an injection speed, a holding time, a holding pressure, a filling speed and a cavity pressure.

6. The auxiliary system for plastic molding according to claim 1, wherein a parameter of the working request signal is selected from the group of a starting time of heating, a total time of heating and a stopping time of heating.

7. The auxiliary system for plastic molding according to claim 1, wherein the plurality of electrical heaters are selected from the group of a resistance heater, an electromagnetic induction heater, a high frequency induction heater, a medium frequency induction heater, a low frequency induction heater, a microwave heater and an infrared sensing heater.
